(19) United States
(12) Patent Application Publication
(10) Pub. No.: US 2024/0427006 A1
(43) Pub. Date: Dec. 26, 2024

(54) WIRELESS TAG COMMUNICATION DEVICE AND WIRELESS TAG SEARCH METHOD

(71) Applicant: TOSHIBA TEC KABUSHIKI KAISHA, Shinagawa-ku, Tokyo (JP)

(72) Inventor: Jun Yaginuma, Izunokuni Shizuoka (JP)

(21) Appl. No.: 18/534,768

(22) Filed: Dec. 11, 2023

(30) Foreign Application Priority Data
Jun. 21, 2023 (JP) 2023-101836

(51) Int. Cl. G01S 13/75; G06K 7/10

(52) U.S. Cl. CPC G01S 13/758; G06K 7/10366

(57) ABSTRACT

Provided is a wireless tag communication device and a wireless tag search method capable of specifying a location where an RFID tag exists. According to one embodiment, a wireless tag communication device includes a communication device, a position detection sensor, a memory, and a processor. The communication device communicates with a wireless tag that is a target. The position detection sensor detects information indicating a self position. The memory stores the self position, which is specified based on the information detected by the position detection sensor, in association with a reading result of reading a wireless tag by the communication device. The processor specifies a position of the wireless tag based on reading results of the wireless tag obtained at a plurality of different positions that are stored in the memory.

### CROSS-REFERENCE TO RELATED APPLICATION

This application is based upon and claims the benefit of priority from Japanese Patent Application No. 2023-101836, filed Jun. 21, 2023, the entire contents of which are incorporated herein by reference.

### FIELD

Embodiments described herein relate generally to a wireless tag communication device and a wireless tag search method.

### BACKGROUND

In the related art, there is a wireless tag communication device for finding an RFID tag (hereinafter also referred to as a wireless tag) located at an unspecified position. The wireless tag communication device communicates with the RFID tag while a position and an orientation of an antenna thereof are changed by an operation of an operator. The wireless tag communication device in the related art estimates a direction in which an RFID tag to be searched exists based on a communication state with the RFID tag to be searched.

The wireless tag communication device in the related art displays, on a display, a guidance screen including an estimation result of the direction in which the RFID tag exists, thereby reporting the direction in which the RFID tag exists to the operator. The operator searches for the RFID tag or an article to which the RFID tag is attached while moving in the direction displayed on the display. However, the wireless tag communication device in the related art reports the direction in which the RFID tag exists, and does not report a position of the RFID tag to be searched. For this reason, regarding the wireless tag communication device in the related art, there is a problem that it takes time for an operator who is unfamiliar with the operation to find the RFID tag.

### DESCRIPTION OF THE DRAWINGS

FIG. 1 is an external view illustrating a configuration example of an external appearance of a wireless tag communication device according to each embodiment;

FIG. 2 is a block diagram schematically illustrating a first configuration example of a control system;

FIG. 3 is a block diagram schematically illustrating a second configuration example of the control system;

FIG. 4 is a diagram illustrating an example of reading areas when a wireless tag communication device according a first embodiment reads, at different positions, an RFID tag to be searched;

FIG. 5 is a diagram illustrating an example of reading areas when the wireless tag communication device according to the first embodiment reads, at different positions, an RFID tag to be searched;

FIG. 6 is a flowchart for explaining an operation example of the wireless tag communication device;

FIG. 7 is a diagram illustrating an example of reading areas when a wireless tag communication device according to a second embodiment reads, at different positions, an RFID tag to be searched;

FIG. 8 is a flowchart for explaining an operation example of the wireless tag communication device;

FIG. 9 is a diagram illustrating an example of a positional relationship when a wireless tag communication device according to a third embodiment reads, at three different positions, an RFID tag to be searched;

FIG. 10 is a diagram illustrating an example of an angle determination table stored in a memory of the wireless tag communication device;

FIG. 11 is a graph for the wireless tag communication device according to the third embodiment to estimate an angle based on a ratio between a distance between two positions and a difference between distances from the two positions to a target tag; and

FIG. 12 is a flowchart for explaining an operation example of the wireless tag communication device.

### DETAILED DESCRIPTION

An embodiment provides a wireless tag communication device and a wireless tag search method capable of specifying a location where an RFID tag exists.

According to one embodiment, a wireless tag communication device includes a communication device, a position detection sensor, a memory, and a processor. The communication device communicates with a wireless tag that is a target. The position detection sensor detects information indicating a self position. The memory stores the self position, which is specified based on the information detected by the position detection sensor, in association with a reading result of reading a wireless tag by the communication device. The processor specifies a position of the wireless tag based on reading results of the wireless tag at a plurality of different positions that are stored in the memory.

Hereinafter, embodiments will be described with reference to the drawings.

First, a configuration of a wireless tag communication device (wireless tag reading device) 1 according to an embodiment will be described.

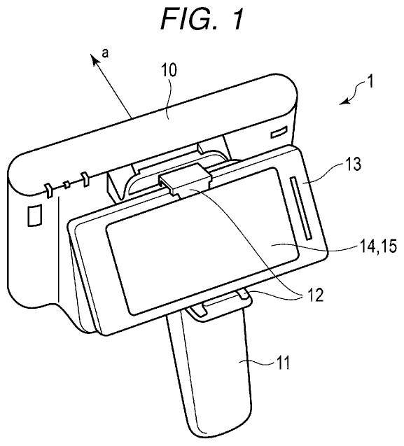

FIG. 1 is a diagram illustrating a configuration example of an external appearance of the wireless tag communication device 1 according to the embodiment.

The wireless tag communication device 1 illustrated in FIG. 1 is a handy-type device that is operated by an operator while being held. The wireless tag communication device 1 illustrated in FIG. 1 is operated as a search device for searching for an RFID tag or an article to which an RFID tag is attached, for example.

The wireless tag communication device 1 according to the embodiment is a device that communicates with an RFID tag (a wireless tag). The wireless tag communication device 1 is a wireless tag reading device that reads tag information and the like recorded in the RFID tag by communicating with the RFID tag. The wireless tag communication device 1 estimates a position where the RFID tag exists based on a reading result of the RFID tag. The wireless tag communication device 1 displays, on a display, a guidance screen indicating information related to the estimated position where the RFID tag exists.

The RFID tag is a wireless communication device that operates in response to a radio wave (an output signal) from the wireless tag communication device 1. The RFID tag includes a processor, a memory, a communication circuit, an antenna, and the like. The RFID tag outputs a response signal including tag information recorded in its own memory in response to a read command from the wireless tag communication device 1. For example, the RFID tag is attached to an article such as a commodity or a part. In an RFID tag attached to an article, tag information including information specifying the article is recorded in an internal memory thereof.

The wireless tag communication device 1 according to the embodiment is operated by an operator. The wireless tag communication device 1 is a device that communicates with a designated RFID tag while being moved. For example, the wireless tag communication device 1 is a handy-type device to be held in the hand of an operator and operated while being moved. The wireless tag communication device 1 may be mounted on a moving body operated by the operator.

The wireless tag communication device 1 according to the embodiment reads an RFID tag attached to an article while a position and an orientation thereof are changed by an operation of the operator. For example, the wireless tag communication device 1 operates as a search device for searching for an article, to which an RFID tag is attached, in a predetermined area (a search range) of a warehouse, a store or the like. The wireless tag communication device 1 serving as a search device continuously reads the RFID tag to be searched while a position thereof is changed by the operation of the operator.

The wireless tag communication device 1 reads tag information recorded in an RFID tag existing in a reading area (a reading range) by receiving a response signal from the RFID tag. Further, the wireless tag communication device 1 also acquires information such as an RSSI value and a phase value from the response (reception) signal from the RFID tag. The wireless tag communication device 1 stores the tag information, the RSSI value, and the phase value obtained from the reception signal together with information such as the position and the orientation of the own device as a reading result in the memory.

In a configuration example illustrated in FIG. 1, the wireless tag communication device 1 includes a reader device (base device) 10 and an information terminal 13 serving as a user interface. The reader device 10 may be provided as the wireless tag communication device 1. In this case, the wireless tag communication device 1 as the reader device 10 is operated in a state where the information terminal 13 as an external device is set as a user interface.

The reader device 10 includes a casing in which an RFID tag interface including an antenna and a communication control circuit is installed. In the reader device 10, the antenna is provided so as to have the strongest directivity in a direction of an arrow a shown in FIG. 1. Here, it is assumed that the direction of the arrow a is a front (front side) direction of the wireless tag communication device 1. Further, it is assumed that the front direction of the wireless tag communication device 1 is an orientation of the antenna.

The reader device 10 includes a grip portion 11 and a holding portion 12 in addition to a configuration of a control system described later. The grip portion 11 is a portion to be gripped by an operator. The holding portion 12 is implemented by a tool for holding the information terminal 13. The holding portion 12 holds the information terminal 13 such that a display screen of a display 14 of the information terminal 13 faces the operator who grips the grip portion 11. The wireless tag communication device 1 is operated by an operator gripping the grip portion 11 in a state where the information terminal 13 is set in the holding portion 12.

The information terminal 13 includes the display 14 and an input device 15. The display 14 and the input device 15 are, for example, display devices with a touch panel. In a state where the information terminal 13 is set in the holding portion 12 of the reader device 10, the operator can visually recognize a screen displayed by the display 14. In addition, in the state where the information terminal 13 is set in the holding portion 12 of the reader device 10, an operation instruction of the operator is input to the input device 15.

The wireless tag communication device 1 continuously reads an RFID tag while being operated by the operator. For example, the operator moves while gripping the grip portion 11 to change the position of the wireless tag communication device 1 provided with the antenna (the position of the own device). The wireless tag communication device 1 repeatedly reads an RFID tag in a reading area set by the orientation of the antenna and a magnitude of a radio wave output from the antenna while estimating the position of the own device.

The wireless tag communication device 1 estimates the position of the own device using a self-estimation technique. For example, the wireless tag communication device 1 estimates, based on an image captured by a camera, a self position (the position of the own device) by a self-position estimation method used in AR (augmented reality) technology. The method, the configuration, and the like for estimating the position of the own device that is used in the wireless tag communication device 1 are not limited to specific ones as long as the self-position can be estimated even in a room or the like.

Based on reading results of RFID tags in the reading area set based on the orientation of the antenna and the magnitude of the radio wave output from the antenna, the wireless tag communication device 1 determines whether an RFID tag to be searched exists in the reading area. For example, the wireless tag communication device 1 stores, in the memory, reading results of the RFID tag to be searched that are obtained in a plurality of reading areas with a plurality of moved positions of the own device as base points. For example, the wireless tag communication device 1 stores information such as the tag information, the position of the own device, the orientation of the antenna, an output value, and the phase value in the memory as a reading result of a specific RFID tag. In addition, the wireless tag communication device 1 may store a reading area specified based on the position of the own device, the orientation of the antenna, the output value, and the like in the memory as the reading result of the specific RFID tag.

The wireless tag communication device 1 estimates the position where the RFID tag to be searched exists based on reading results obtained at a plurality of positions that are stored in the memory. For example, the wireless tag communication device 1 estimates the position of the RFID tag to be searched (a tag position) based on reading areas corresponding to a plurality of positions of the own device at which the RFID tag to be searched is read. Further, the wireless tag communication device 1 estimates the position of the RFID tag to be searched based on movement distances between a plurality of positions where the RFID tag to be searched is read, reading results obtained at the positions, and the like.

Next, a configuration of a control system in the wireless tag communication device 1 according to the embodiment will be described.

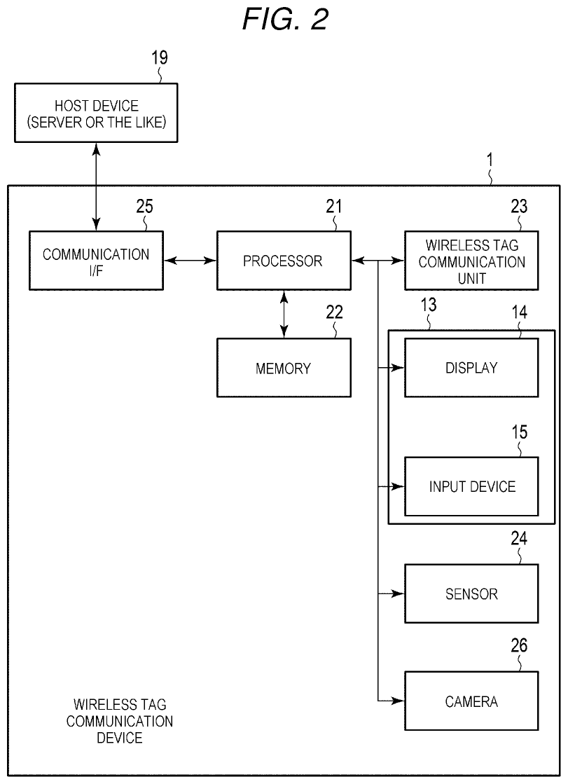

FIG. 2 is a block diagram schematically illustrating a first configuration example of the control system in the wireless tag communication device 1 according to the embodiment.

In the configuration example illustrate in FIG. 2, the wireless tag communication device 1 includes a processor 21, a memory 22, a wireless tag communication unit 23, a sensor 24, a communication interface (I/F) 25, a camera 26, the display 14, and the input device 15.

The processor 21 controls the units. The processor 21 includes, for example, an arithmetic circuit such as a CPU. The processor 21 implements control of the units and various types of data processing by executing a program. The processor 21 may include an internal memory. The processor 21 executes various types of processing by executing programs stored in the memory 22 or the like.

The memory 22 includes various memories. For example, the memory 22 includes memories such as a ROM, a RAM, and an NVM. The ROM is a non-rewritable nonvolatile memory. The ROM stores a program or the like executed by the processor 21. The RAM is a volatile memory that temporarily stores data. The RAM operates as a working memory or a buffer memory.

The NVM of the memory 22 is a rewritable nonvolatile memory. The memory 22 stores information such as control information, setting information, and processing results in the NVM. In addition, the memory 22 stores, in the NVM, various programs for the processor 21 to execute various types of processing to be described later. For example, the memory 22 stores, in the NVM, an operation support program for outputting information for supporting the operator's operation on the casing. In addition, the memory 22 stores, in the NVM, an evaluation reference value for the operation support program to evaluate the operation on the casing.

The wireless tag communication unit 23 is a communication device constituting an RFID interface for communicating with an RFID tag. The wireless tag communication unit 23 is, for example, a communication device including a communication control circuit and an antenna. The wireless tag communication unit 23 may be implemented by a connection interface to be connected to an external antenna.

In the wireless tag communication unit 23, the communication control circuit includes a control circuit for communicating with the RFID tag via the antenna. The communication control circuit causes the antenna to transmit, at a set output value, a transmission signal (a radio wave) supplied from the processor 21. The antenna outputs the transmission signal supplied from the communication control circuit as a radio wave receivable by the RFID tag. The wireless tag communication unit 23 sets a range (a reading area, a reading range), in which the RFID tag can give a response, based on the orientation of the antenna and the output value of the radio wave output from the antenna.

In the wireless tag communication unit 23, the communication control circuit not only outputs a transmission signal to the antenna but also supplies a signal received by the antenna as reception data to the processor 21. The antenna receives a response signal from the RFID tag, and the communication control circuit processes the response signal (a reception signal) received by the antenna and supplies the processed signal to the processor 21. For example, the communication control circuit supplies tag information included in the reception signal from the RFID tag, an RSSI value indicating a strength of the reception signal, and a phase value to the processor 21.

The sensor (a sensor group) 24 detects movement of the wireless tag communication device 1. For example, the sensor 24 is an acceleration sensor, a gyro sensor, or a magnetic field (azimuth) sensor. The sensor 24 may include a plurality of types of sensors. The sensor 24 may include a position detection sensor configured to detect a position of the wireless tag communication device 1. The sensor 24 is an example of the position detection sensor.

The communication I/F 25 is an interface for communicating with an external device. The communication I/F 25 is a communication interface for communicating with a host device 19 such as a server. The communication I/F 25 may be an interface for wired communication or an interface for wireless communication.

The camera 26 captures an image. An imaging direction of the camera 26 changes according to the orientation of the wireless tag communication device 1. For example, the imaging direction in which the camera 26 performs imaging may be set to coincide with the orientation of the antenna of the wireless tag communication unit 23. The image captured by the camera 26 is used to estimate the position of the wireless tag communication device 1 (the position of the own device). The camera 26 is an example of the position detection sensor. For example, the wireless tag communication device 1 estimates, based on an image captured by the camera 26, the self position (the position of the own device) by a self-position estimation method used in AR (augmented reality) technology.

The display 14 and the input device 15 provided in the information terminal 13 are connected to the processor 21 via an internal interface. The display 14 is a device configured to display information. For example, the display 14 displays a display screen instructed by the processor 21. The input device 15 is a device for an operator to input an operation instruction or the like. The input device 15 supplies information indicating contents instructed by the operator to the processor 21.

The wireless tag communication device 1 includes a power supply configured to supply power for operation. The handy-type wireless tag communication device 1 includes, for example, a rechargeable battery (a secondary battery) as the power supply. The battery supplies power for operating the units in the wireless tag communication device 1 to the units. The camera 26 in the wireless tag communication unit 1 may be replaced with a device for specifying the position of the wireless tag communication unit 1.

Next, the configuration of the control system in the wireless tag communication device 1 according to the embodiment will be described.

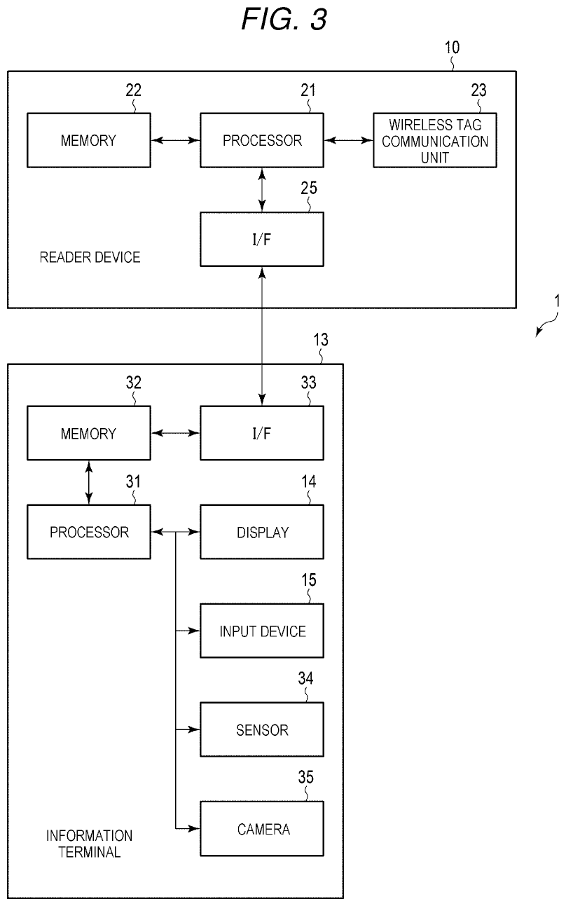

FIG. 3 is a block diagram schematically illustrating a second configuration example of the control system in the wireless tag communication device 1 according to the embodiment.

In the configuration example illustrated in FIG. 3, the reader device 10 serving as the wireless tag communication device 1 is connected to the information terminal 13 serving as an external device. The reader device 10 serving as the wireless tag communication device 1 includes the processor 21, the memory 22, the wireless tag communication unit 23, and an interface (I/F) 25.

The processor 21 controls the units. The processor 21 includes, for example, an arithmetic circuit such as a CPU. The processor 21 implements control of the units and various types of data processing by executing a program. The processor 21 may include an internal memory. The processor 21 executes various types of processing by executing programs stored in the memory 22 or the like.

The memory 22 includes various memories. For example, the memory 22 includes memories such as a ROM, a RAM, and an NVM. The ROM is a non-rewritable nonvolatile memory. The ROM stores a program or the like executed by the processor 21. The RAM is a volatile memory that temporarily stores data. The RAM operates as a working memory or a buffer memory. The NVM is a rewritable nonvolatile memory. The NVM stores information such as control information, setting information, and processing results. The NVM of the memory 22 stores various programs for the processor 21 to execute various types of processing described later.

The wireless tag communication unit 23 is a communication device constituting an RFID interface for communicating with an RFID tag. The wireless tag communication unit 23 is a communication device including a communication control circuit and an antenna. The wireless tag communication unit 23 may be implemented by a connection interface to be connected to an external antenna.

In the wireless tag communication unit 23, the communication control circuit includes a control circuit for communicating with the RFID tag via the antenna. The communication control circuit causes the antenna to transmit, at a set output value, a transmission signal (a radio wave) supplied from the processor 21. The antenna outputs the transmission signal supplied from the communication control circuit as a radio wave receivable by the RFID tag. The wireless tag communication unit 23 sets a range (a reading area), in which the RFID tag can give a response, based on an orientation of the antenna and the output value of the radio wave output from the antenna.

In the wireless tag communication unit 23, the communication control circuit not only outputs a transmission signal to the antenna but also supplies a signal received by the antenna as reception data to the processor 21. The antenna receives a response signal from the RFID tag, and the communication control circuit processes the response signal (a reception signal) received by the antenna and supplies the processed signal to the processor 21. For example, the communication control circuit supplies tag information included in the reception signal from the RFID tag, an RSSI value indicating a strength of the reception signal, and a phase value to the processor 21.

It is sufficient that the interface 25 corresponds to an interface 33 provided in the information terminal 13. For example, the interface 25 may be physically connected to an interface provided in the information terminal 13, such as a universal serial bus (USB) interface or a LAN interface. Further, the interface 25 may be a Bluetooth (registered trademark) interface or a WiFi (registered trademark) interface for wireless communication connection.

The reader device 10 serving as the wireless tag communication device 1 includes a power supply configured to supply power for operation. The handy-type wireless tag communication device 1 a includes, for example, rechargeable battery (a secondary battery) as the power supply. The battery supplies power for operating the units in the wireless tag communication device 1 to the units. In the configuration example illustrated in FIG. 3, the information terminal 13 is set in the holding portion 12 of the reader device 10 serving as the wireless tag communication device 1. The information terminal 13 includes the display 14, the input device 15, and the like, and may be any device that is communicably connected to the reader device 10 serving as the wireless tag communication device 1. The information terminal 13 is, for example, a portable information processing apparatus such as a smartphone or a tablet PC.

As illustrated in FIG. 3, the information terminal 13 includes a processor 31, a memory 32, an interface (I/F) 33, a sensor 34, a camera 35, the display 14, and the input device 15.

The processor 31 controls the units and performs data processing. The processor 31 is, for example, a CPU. The processor 31 implements various operations by executing programs stored in the memory 32.

The interface 33 is an interface (a second communication interface) for communication connection with the interface 25. It is sufficient that the interface 33 corresponds to the interface 25. For example, the interface 33 is a LAN interface, a USB interface, a Bluetooth (registered trademark) interface, or a WiFi (registered trademark) interface.

The sensor (a sensor group) 34 includes a sensor configured to detect movement of the information terminal 13. For example, the sensor 34 is an acceleration sensor, a gyro sensor, or a magnetic field (azimuth) sensor. The sensor 34 may include a plurality of types of sensors. The sensor 34 may include a position detection sensor for detecting a position. In this case, the sensor 34 is an example of the position detection sensor. A part or all of sensors serving as the sensor 34 as described above may be provided in the reader device 10.

The camera 35 captures an image. An imaging direction of the camera 35 changes according to an orientation of the reader device 10 in a state where the information terminal 13 is set to the reader device 10. For example, the imaging direction in which the camera 35 performs imaging may be set to coincide with the orientation of the antenna of the wireless tag communication unit 23 provided in the reader device 10.

The image captured by the camera 35 is used to estimate a position of the information terminal 13 (a position of the wireless tag communication device 1 including the reader device 10 to which the information terminal 13 is set, that is, a position of an own device). The camera 35 is an example of a position detection sensor. For example, the processor 31 of the information terminal 13 estimates, based on an image captured by the camera 35, a self position (the position of the own device) by a self-position estimation method used in AR (augmented reality) technology.

Next, a configuration of the wireless tag communication unit 23 in the wireless tag communication device 1 according to the embodiment will be described in detail.

As described above, the wireless tag communication unit (communication device) 23 includes a communication control circuit and an antenna. The communication control circuit of the wireless tag communication unit 23 includes a modulation circuit, a transmission-side amplifier circuit, a coupler, a reception-side amplifier circuit, a demodulation circuit, an output setting circuit, and a level detection circuit. The antenna of the wireless tag communication unit 23 is connected to the coupler of the communication control circuit. The antenna transmits and receives radio waves for communicating with an RFID tag. The communication control circuit processes a signal to be transmitted to the RFID tag via the antenna and a signal received from the RFID tag via the antenna.

The modulation circuit modulates a waveform signal (a carrier wave) with input transmission data. The transmission-side amplifier circuit amplifies an output signal of the modulation circuit. The coupler supplies an output signal of the transmission-side amplifier circuit to the antenna. With these configurations, the communication control circuit outputs the carrier wave modulated with the transmission data from the antenna.

The RFID tag receives a radio wave as a transmission signal transmitted from the antenna. The RFID tag recognizes, for example, a read command included in the transmission signal transmitted from the antenna. When the RFID tag recognizes the read command, the RFID tag outputs data (tag information) stored in its own memory in the form of a radio wave, for example, by backscatter modulation.

The antenna receives the radio wave as a reception signal output from the RFID tag. The communication control circuit acquires, using the coupler, the reception signal received by the antenna, and supplies the acquired reception signal to the reception-side amplifier circuit. The reception-side amplifier circuit amplifies the reception signal received by the antenna. The demodulation circuit demodulates the data (the tag information) included in the reception signal amplified by the reception-side amplifier circuit.

The antenna of the wireless tag communication unit 23 has directivity, and is installed at a predetermined position of the wireless tag communication device 1 and faces a predetermined direction. The antenna is, for example, a planar antenna. The antenna of the wireless tag communication unit 23 is not limited to a specific configuration. The antenna is disposed in a casing so as to transmit an electromagnetic wave (an output signal) toward a communication area (a reading area) centered on a direction (for example, a-direction shown in FIG. 1) in which the directivity is maximum. The wireless tag communication device 1 is configured such that the direction in which the directivity of the antenna is maximum is the front (the a-direction shown in FIG. 1).

The communication control circuit of the wireless tag communication unit 23 sets, by using the output setting circuit, a strength (an output value) of a signal to be output. The transmission-side amplifier circuit amplifies a signal, which is supplied from the modulation circuit, to the output value set by the output setting circuit. The antenna transmits an output signal (a radio wave) at an output value set by the output setting circuit, which is supplied from the transmission-side amplifier circuit via the coupler.

The wireless tag communication unit 23 sets a range (a reading area) for transmitting a radio wave to which an RFID tag can give a response, the range corresponding to the orientation of the antenna and the output value of the radio wave output from the antenna. The reading area by the wireless tag communication unit 23 is set based on the orientation of the antenna, the directivity of the antenna, and the output value of the output signal. The wireless tag communication unit 23 sets the reading area by controlling the output value of the output signal in accordance with an instruction from the processor 21.

The communication control circuit of the wireless tag communication unit 23 processes a response signal (a reception signal) received by the antenna and supplies the processed signal to the processor 21. The communication control circuit supplies tag information included in the reception signal from the RFID tag, an RSSI value indicating a strength of the reception signal, and a phase value to the processor 21. For example, the communication control circuit of the wireless tag communication unit 23 detects, by using the level detection circuit, information for specifying the RSSI value indicating the strength of the reception signal (the response signal from the RFID tag) received by the antenna. In addition, the processor 21 acquires phase values of a plurality reception signals received by the communication control circuit of the wireless tag communication unit 23 at different positions, and detects a phase difference between the reception signals received at the different positions.

Hereinafter, first, second, and third embodiments applied to the wireless tag communication device 1 having the above-described configuration will be described.

### First Embodiment

First, the first embodiment applied to the wireless tag communication device 1 having the above-described configuration will be described.

In the first embodiment, the wireless tag communication device 1 reads, at a plurality of positions, an RFID tag to be searched (hereinafter, referred to as a target tag). The wireless tag communication device 1 according to the first embodiment reads the target tag at the plurality of positions, and estimates (determines) a position of the target tag based on reading areas when the target tag is read.

With the above-described configuration, the processor 21 of the wireless tag communication device 1 detects the position of the own device and the orientation of the antenna by using the sensor 24 (34) or based on an image captured by the camera 26 (35). Further, the processor 21 acquires an output value of a radio wave (output signal) output from the wireless tag communication unit 23. The processor 21 specifies the reading area based on the position of the own device, the orientation of the antenna, and the output value of the output signal.

The processor 21 of the wireless tag communication device 1 reads the target tag at a plurality of positions. The processor 21 of the wireless tag communication device 1 specifies reading areas at the plurality of positions where the target tag is read. The processor 21 of the wireless tag communication device 1 specifies a common area (overlapping area) of the reading areas at the plurality of positions where the target tag is read. The processor 21 determines (estimates) that the target tag exists in the common area.

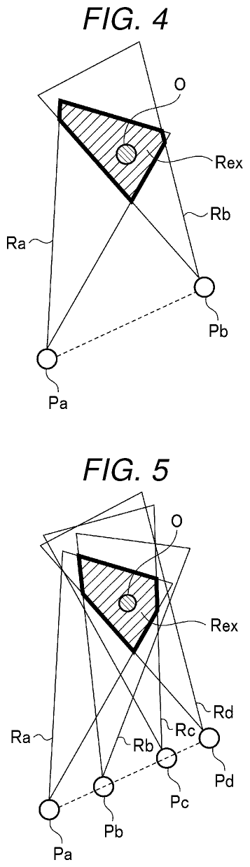

FIGS. 4 and 5 are diagrams illustrating examples of the reading areas when the wireless tag communication device 1 reads, at different positions, an RFID tag O to be searched.

In the example illustrated in FIG. 4, it is assumed that the wireless tag communication device 1 reads the target tag O at a first position Pa and a second position Pb. For example, an operator reads the target tag O at the first position Pa using the wireless tag communication device 1. The operator who reads the target tag O at the first position Pa moves to the second position Pb while gripping the wireless tag communication device 1. The operator who moves to the second position Pb reads the target tag O again using the wireless tag communication device 1.

When the target tag O is read at the first position Pa, the processor 21 of the wireless tag communication device 1 specifies a reading area Ra with the position Pa as a base point based on the position of the own device, the orientation of the antenna, the output value of the output signal, and the like. Further, the processor 21 of the wireless tag communication device 1 specifies a reading area Rb with the position Pb as a base point when the target tag O is read at the second position Pb.

The processor 21 of the wireless tag communication device 1 specifies a common area Rex common to the reading area Ra and the reading area Rb where the target tag O is read. If the target tag O is not moved, the target tag O exists in the common area Rex as illustrated in FIG. 4. Therefore, the processor 21 determines that the common area Rex is an existence area of the target tag O.

In the example illustrated in FIG. 5, the wireless tag communication device 1 reads the target tag O at first, second, third, and fourth positions Pa, Pb, Pc, and Pd. For example, it is assumed that the operator gripping the wireless tag communication device 1 reads the target tag O at the positions Pa, Pb, Pc, Pd while moving from the first position Pa to the fourth position Pd.

When the target tag O is read at the first position Pa, the processor 21 of the wireless tag communication device 1 specifies the reading area Ra with the position Pa as a base point. Further, when the target tag O is read at the second position Pb, the processor 21 of the wireless tag communication device 1 specifies the reading area Rb with the position Pb as a base point. When the target tag O is read at the third position Pc, the processor 21 of the wireless tag communication device 1 specifies a reading area Rc with the position Pc as a base point. Further, when the target tag O is read at the fourth position Pd, the processor 21 of the wireless tag communication device 1 specifies a reading area Rd with the position Pd as a base point.

When the target tag O is read at the four positions, the processor 21 of the wireless tag communication device 1 specifies the common area Rex common to all the reading areas Ra, Rb, Rc, and Rd. Also in this case, if the target tag O is not moved, the target tag O exists in the common area Rex as illustrated in FIG. 5. Therefore, the processor 21 of the wireless tag communication device 1 determines that the common area Rex is an area where the target tag O exists.

Next, operations of the wireless tag communication device 1 according to the first embodiment will be described.

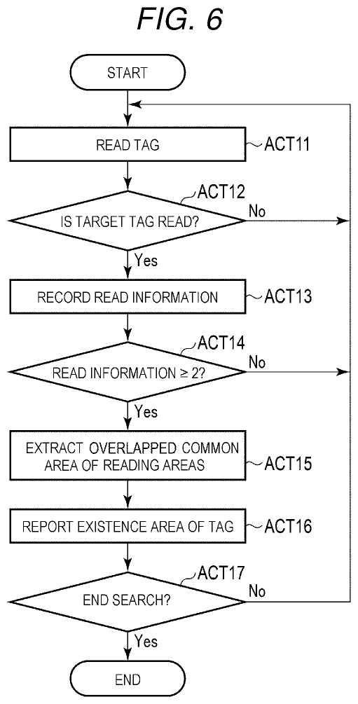

FIG. 6 is a flowchart for explaining an operation example of the wireless tag communication device 1 according to the first embodiment.

First, an operator as a searcher who performs a search operation of an RFID tag inputs, by using the input device 15 of the wireless tag communication device 1, information for registering himself/herself as a searcher. The processor 21 of the wireless tag communication device 1 registers the operator, who is the searcher, based on the information input via the input device 15.

When the searcher is registered, the processor 21 of the wireless tag communication device 1 operates in a search mode by the searcher (an operation of the operator). The processor 21 receives setting of the RFID tag or the like to be searched by the operator. After the RFID tag to be searched (the target tag) is set, the processor 21 receives an instruction to start searching from the operator.

The processor 21 of the wireless tag communication device 1 starts reading the target tag in response to the instruction to start searching from the operator (ACT 11). The processor 21 outputs a response request (a read command) by the wireless tag communication unit 23 as an output signal of a predetermined output value. The wireless tag communication unit 23 receives a reception (response) signal that is a response wave output from an RFID tag in a reading area. Upon receiving the signal from the RFID tag, the wireless tag communication unit 23 extracts tag information indicated by the reception signal and supplies the extracted tag information to the processor 21.

Based on the tag information included in the signal received by the wireless tag communication unit 23, the processor 21 determines whether the target tag is read (ACT 12). The processor 21 identification specifies information included in the tag information of the reception signal received by the wireless tag communication unit 23. The processor 21 determines whether the target tag is read by determining whether the identification information included in the reception signal coincides with identification information of the target tag.

When the target tag is not read (ACT 12, NO), the processor 21 returns to ACT 11 and performs reading of an RFID tag.

When the target tag is read (ACT 12, YES), for example, the processor 21 stores (records) read information, which is a reading result of the target tag, in the memory 22 (ACT 13). For example, the processor 21 holds read information such as a position, an orientation (reading direction), an output value, and a phase value in the memory 22 as the reading result of the target tag. The processor 21 may record, as the reading result of the target tag, information indicating the reading area that is specified based on the position, the orientation, the output value, and the like.

The position is information indicating a position of the own device (the wireless tag communication device 1) when the RFID tag is read. For example, the processor 21 estimates, based on an image captured by the camera 26 or 35, a self position (the position of the own device) by a self-position estimation method used in AR (augmented reality) technology. The processor 21 may acquire information indicating the self position that is estimated by the processor 31 of the information terminal 13 based on an image captured by the camera 35. The processor 21 may specify the position of the own device based on information other than the image captured by the camera.

The orientation (reading direction) is information indicating the orientation of the antenna (orientation of the wireless tag communication device 1) when the RFID tag is read. The processor 21 acquires information indicating the orientation of the antenna that is detected by the sensor 24 or 34. The processor 21 may detect the orientation of the antenna based on an image captured by the camera 26 or 35.

The output value is a strength of an output signal (a radio wave) output from the antenna when the RFID tag is read. The output value is set by the output setting circuit of the communication control circuit according to an instruction from the processor 21.

The phase value is a phase of the radio wave that is a reception signal received by the antenna from the target tag. The phase value is detected from the reception signal of the target tag by a phase detection circuit provided in the communication control circuit. The processor 21 acquires the phase value detected by the phase detection circuit.

When the read information that is the reading result of the target tag is recorded, the processor 21 determines whether there are two or more (plural) pieces of read information that are the reading result of the target tag (ACT 14). However, the processor 21 determines whether there are a plurality of pieces of read information obtained at least at different positions where the target tag is read. For example, it is assumed that reading results of reading the target tag at the same position are determined as one piece of read information.

When there are not two or more pieces of read information of the target (only one piece of read information) (ACT 14, NO), the processor 21 returns to ACT 11 and performs reading of the RFID tag.

When there are two or more pieces of read information of the target tag (ACT 14, YES), the processor 21 extracts a common area where reading areas when the target tag is read overlap (ACT 15). The processor 21 specifies the reading areas when the target tag is read, based on the plurality of pieces of read information of the target tag. The processor 21 specifies the reading areas when the target tag is read, based on the read information of the target tag obtained at different positions. The processor 21 extracts an area (common area) where the plurality of reading areas when the target tag is read at different positions overlap.

When the common area is extracted, the processor 21 reports the common area as an area (an existence area) where the target tag exists (ACT 16). For example, the processor 21 displays, on the display 14, information indicating the specified existence area of the target tag. Accordingly, the operator can directly know not a direction in which the target tag exists but the area in which the target tag exists.

When the existence area of the target tag is reported, the processor 21 receives an instruction to end the search (ACT 17). When the instruction to end the search is not given (ACT 17, NO), the processor 21 returns to ACT 11 and performs reading of the RFID tag. When the instruction to end the search is given (ACT 17, YES), the processor 21 ends the search of the target tag. The processor 21 may receive the instruction to end the search at any timing.

As described above, the wireless tag communication device according to the first embodiment stores, in a memory, a self position in association with a reading result of a target tag. The wireless tag communication device specifies, based on information stored in the memory, a first reading area when the target tag is read at a first position and a second reading area when the target tag is read at a second position. The wireless tag communication device specifies an overlapping area (common area) where the first reading area and the second reading area overlap, as an existence area where the target tag exists.

Accordingly, according to the wireless tag communication device of the first embodiment, it is possible to specify the area in which the target tag exists, not a direction in which the target tag exists. As a result, according to the wireless tag communication device of the first embodiment, it is possible to report the area where the target tag exists to the operator.

### Second Embodiment

Next, a second embodiment applied to the wireless tag communication device 1 having the above-described configuration will be described.

In the second embodiment, the wireless tag communication device 1 reads, at a plurality of positions, an RFID tag to be searched as in the first embodiment. However, when reading the target tag, the wireless tag communication device 1 according to the second embodiment decreases an output value of an output signal and executes reading of the target tag again. That is, the wireless tag communication device 1 according to the second embodiment repeats reading of the target tag by decreasing the output value each time the target tag is read. The wireless tag communication device 1 according to the second embodiment converts the output values to estimate (determine) a position where the target tag exists based on reading areas when the target tag is read at a plurality of positions.

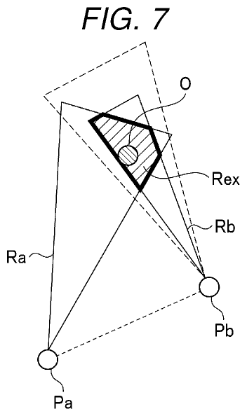

FIG. 7 is a diagram illustrating an example of reading areas when the wireless tag communication device 1 according to the second embodiment reads, at different positions, the RFID tag O to be searched.

In the example illustrated in FIG. 7, it is assumed that the wireless tag communication device 1 reads the target tag O with different output values at the first position Pa and the second position Pb. For example, the operator who grips the wireless tag communication device 1 reads the target tag O at the first position Pa and then moves to the second position Pb to read the target tag O again. After reading the target tag at the first position Pa, the wireless tag communication device 1 decreases the output value and reads the target tag O at the second position Pb.

When the target tag O is read at the first position Pa, the processor 21 of the wireless tag communication device 1 specifies the reading area Ra with the position Pa as a base point. Further, when the target tag O is read at the second position Pb, the processor 21 of the wireless tag communication device 1 specifies the reading area Rb with the position Pb as a base point.

The processor 21 of the wireless tag communication device 1 specifies the reading area based on a position, an orientation, and an output value. In the reading at the second position Pb, the output value is made smaller than that in the reading at the first position Pa. Therefore, in the example illustrated in FIG. 7, the reading area Rb is smaller than the reading area Ra. That is, as the output value decreases, the reading area decreases, and thus the common area Rex also decreases.

The common area Rex common to the reading area Ra and the reading area Rb where the target tag O is read is an existence area where the target tag O exists. Accordingly, the wireless tag communication device 1 can narrow down the area where the target tag O exists to a small range by reducing the output value of the output signal every time the target tag is read.

Next, the operation of the wireless tag communication device 1 according to the second embodiment will be described.

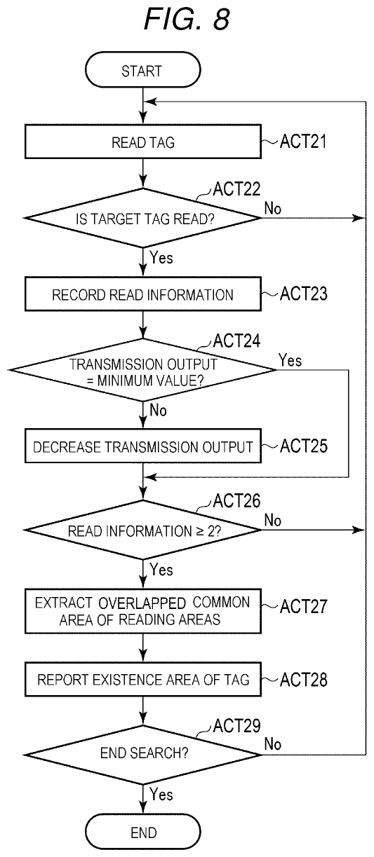

FIG. 8 is a flowchart for explaining an operation example of the wireless tag communication device 1 according to the second embodiment.

The processor 21 of the wireless tag communication device 1 operates in a search mode after registering an operator who is a searcher based on information input via the input device 15. After setting an RFID tag to be searched (a target tag) that is designated by the operator, the processor 21 starts reading the target tag in response to an instruction to start the search from the operator (ACT 21). The processor 21 receives a reception signal, which is a response wave output from the RFID tag in a reading area in response to a response request (a read command) from the wireless tag communication device 1.

Based on tag information included in the reception signal, the processor 21 determines whether the RFID tag to be searched (the target tag) is read (ACT 22). When the target tag is not read (ACT 22, NO), the processor 21 returns to ACT 21 and performs reading of the RFID tag.

When the target tag is read (ACT 22, YES), the processor 21 stores (records) read information, which is a reading result of the target tag, in the memory 22 (ACT 23). For example, the processor 21 holds read information such as a position, an orientation (reading direction), an output value, and a phase value in the memory 22 as the reading result of the target tag. The processor 21 may record, as the reading result of the target tag, information indicating the reading area that is specified based on the position, the orientation, the output value, and the like.

When the read information that is the reading result of the target tag is recorded, the processor 21 determines whether an output value (transmission output) set by the wireless tag communication unit 23 is a predetermined minimum value (ACT 24). The predetermined minimum value is a minimum value that can be set by the wireless tag communication unit 23 as an output signal used for reading the RFID tag. When the output value of the transmission signal set by the wireless tag communication unit 23 is the predetermined minimum value (ACT 24, YES), the processor 21 proceeds to ACT 26.

When the current output value is not the predetermined minimum value (ACT 24, NO), the processor 21 decreases the output value of the output signal (transmission output) set in the communication control circuit of the wireless tag communication unit 23 (ACT 25). For example, the processor 21 decreases the output value stepwise until the output value is the minimum value that can be set. When the output value is decreased, the reading area of the RFID tag is decreased for the wireless tag communication device 1. That is, the processor 21 limits (decreases) the reading area of the target tag stepwise by decreasing the output value stepwise. Accordingly, the wireless tag communication device 1 can specify, in a limiting manner, the position (area) where the target tag exists.

In addition, a fluctuation range (a fluctuation value) for decreasing the output value may be a preset fixed value, or the fluctuation range may gradually decrease. The fluctuation value may be a value set according to the strength (for example, RSSI value) of the reception signal when the target tag is read. For example, the fluctuation value may be increased if the RSSI value of the reception signal when the target tag is read is large, and may be decreased if the RSSI value of the reception signal when the target tag is read is small.

When the output value is changed or when the output value is the minimum value, the processor 21 determines whether there are two or more (plural) pieces of the read information that is the reading result of the target tag (ACT 26). When there are not two or more pieces of read information of the target tag (only one piece of read information) (ACT 26, NO), the processor 21 returns to ACT 21 and performs reading of the RFID tag.

When there are two or more pieces of read information of the target tag (ACT 26, YES), the processor 21 extracts a common area where reading areas when the target tag is read at different positions overlap (ACT 27). The processor 21 specifies the reading areas (a plurality of reading areas) based on the plurality of pieces of read information that is a result of reading the target tag at the different positions. When a plurality of reading areas when the target tag is read at different positions are specified, the processor 21 specifies (extracts) an area (common area) where the plurality of reading areas overlap.

When the common area is extracted, the processor 21 reports the common area as an area (an existence area) where the target tag exists (ACT 28). For example, the processor 21 displays, on the display 14, information indicating the specified existence area of the target tag. Accordingly, the operator can directly know not a direction in which the target tag exists but the area in which the target tag exists.

The processor 21 receives an instruction to end the search. For example, the processor 21 may receive the instruction to end the search when the existence area of the target tag is reported, or may receive the instruction to end the search at any timing. When the instruction to end the search is not given (ACT 29, NO), the processor 21 returns to ACT 21 and performs reading of the RFID tag. When the instruction to end the search is given (ACT 29, YES), the processor 21 ends the search of the target tag.

As described above, the wireless tag communication device according to the second embodiment stores, in a memory, a self position in association with a reading result of a target tag. The wireless tag communication device decreases an output value of a transmission signal after reading the target tag at a first position and reads the target tag at a second position. The wireless tag communication device specifies a first reading area when the target tag is read at the first position and specifies a second reading area narrower than the first reading area when the target tag is read at the second position. The wireless tag communication device specifies an overlapping area (common area) where the first reading area and the second reading area narrower than the first reading area overlap, as an existence area where the target tag exists.

Accordingly, according to the wireless tag communication device of the second embodiment, the reading areas at a plurality of positions can be set in a gradual decreasing order by gradually decreasing the output value of the transmission signal. According to the wireless tag communication device of the second embodiment, since the reading areas at a plurality of positions are set in a gradual decreasing order, the area where the target tag exists can be gradually narrowed down and specified. As a result, according to the wireless tag communication device of the second embodiment, it is possible to narrow down the existence area of the target tag and report the existence area of the target tag to the operator.

### Third Embodiment

Next, a third embodiment applied to the wireless tag communication device 1 the above-described having configuration will be described.

The wireless tag communication device 1 according to the third embodiment estimates (determines) directions of a target tag at a plurality of positions, and estimates (determines) a position of the target tag based on the directions of the target tag from the plurality of positions. The wireless tag communication device 1 according to the third embodiment reads the target tag at the plurality of positions, and estimates the direction of the target tag from any position based on a reading result obtained at the corresponding position and a reading result obtained at a next position. The wireless tag communication device 1 according to the third embodiment estimates the position of the target tag based on the directions of the target tag from the plurality of positions.

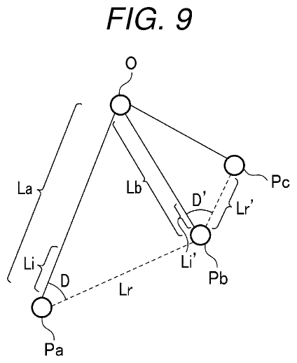

FIG. 9 is a diagram illustrating an example of a positional relationship when the wireless tag communication device 1 according to the third embodiment reads, at three different positions, the RFID tag O to be searched.

In the example illustrated in FIG. 9, it is assumed that the wireless tag communication device 1 reads the target tag O at the first position Pa, the second position Pb, and the third position Pc. For example, an operator who grips the wireless tag communication device 1 reads the target tag O while moving sequentially in the first position Pa, the second position Pb, and the third position Pc.

The processor 21 of the wireless tag communication device 1 holds, in the memory 22, read information including a position of an own device and a phase of a reception signal, as a result of reading the target tag at each position. The processor 21 determines a distance Lr between the first position Pa and the second position Pb based on the read information obtained at the first position Pa and the read information obtained at the second position Pb. The processor 21 determines a difference distance Li between a distance PaO from the first position Pa to the target tag O and a distance PbO from the second position Pb to the target tag O.

A difference distance Li is calculated by a difference (a phase difference) between the phase of the reception signal (a response wave) received at the first position Pa and the phase of the reception signal (a response wave) received at the second position Pb. That is, the difference distance (Li=La−Lb) between the distance La from the first position Pa to the target tag O and the distance Lb from the second position Pb to the target tag O is presented as a phase difference. Accordingly, the processor 21 determines the difference distance Li based on the phase difference obtained from the read information obtained at the first position Pa and the read information obtained at the second position Pb.

The processor 21 derives (estimates) an angle D of an angle OAB from a ratio Li/Lr between the distance Lr and the difference distance Li. Here, the angle D derived (estimated) from the ratio Li/Lr is stored in the memory 22 in advance as an angle determination table. After calculating the ratio Li/Lr, the processor 21 determines the angle D corresponding to the calculated ratio Li/Lr based on the angle determination table.

In FIG. 9, an angle OPaPb is the angle D formed by a line segment PaPb and a line segment PaO. Therefore, when the positions (position coordinates) of the position Pa and the position Pb are specified, a direction from the position Pa to the target tag O (a straight line passing through the position Pa and the target tag O) can be specified. The processor 21 determines the direction from the position Pa to the target tag O based on the angle D of the angle OAB determined from the ratio Li/Lr.

By the same method as described above, the processor 21 determines a distance Lr′ between the second position Pb and the third position Pc based on the read information obtained at the second position Pb and the read information obtained at the third position Pc. The processor 21 determines a difference distance Li′ between the distance PbO from the second position Pb to the target tag O and a distance PcO from the third position Pc to the target tag O. The difference distance Li′ is determined based on a phase difference obtained from the read information obtained at the second position Pb and the read information obtained at the third position Pc.

The processor 21 calculates a ratio Li′/Lr′ between the distance Lr′ and the difference distance Li′, and determines an angle D′ corresponding to the calculated Li′/Lr′ based on the angle determination table. The processor 21 determines a direction of the target tag O from the second position Pb (a straight line passing through the position Pb and the target tag O) based on the angle D′ of the angle OPbPc determined from the ratio Li′/Lr′.

The processor 21 determines (estimates) the position of the target tag O based on the direction of the target tag from the first position Pa and the direction of the target tag from the second position Pb. For example, the processor 21 determines an intersection between a straight line PaO passing through the first position Pa and the target tag O and a straight line PbO passing through the second position Pb and the target tag O as the position of the target tag O.

That is, the wireless tag communication device 1 according to the third embodiment determines (estimates) a direction from one position to the target tag based on the read information of the target tag at two positions. The wireless tag communication device 1 according to the third embodiment reads the target tag at three or more positions and determines directions to the target tag from a plurality of positions. The wireless tag communication device 1 according to the third embodiment determines the position of the target tag based on the directions from the plurality of positions to the target tag.

Next, an angle determination table for the wireless tag communication device 1 according to the third embodiment to determine a direction of a target tag will be described.

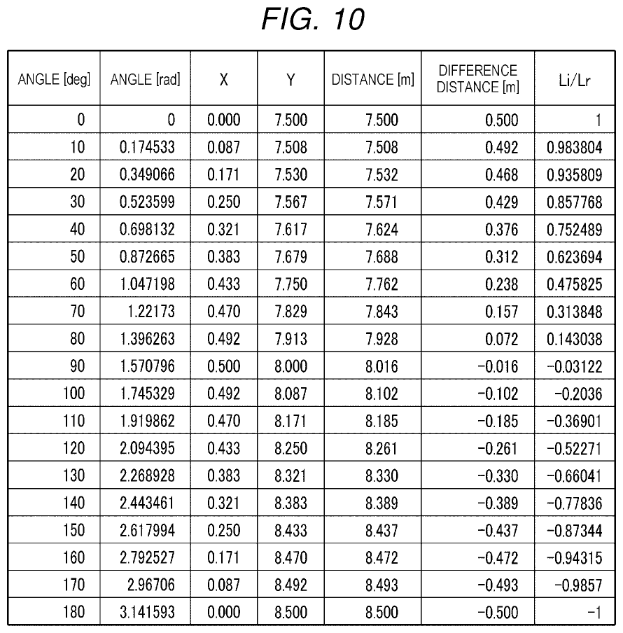

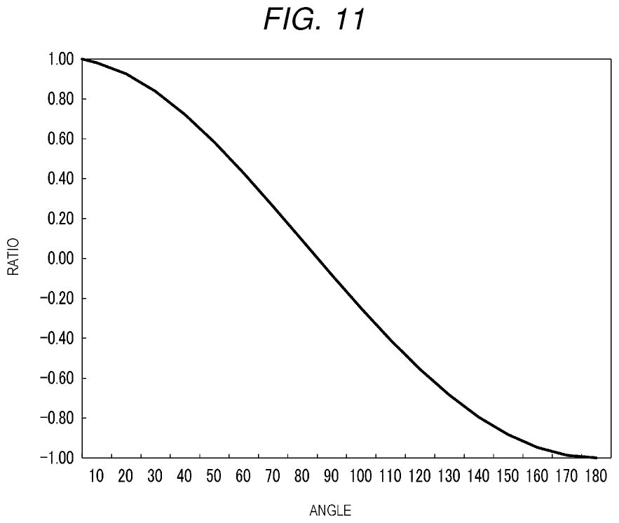

FIG. 10 is a diagram illustrating an example of the angle determination table stored in the memory 22 of the wireless tag communication device 1 according to the third embodiment. FIG. 11 is a graph illustrating a relationship between the angle D and the ratio Li/Lr, the ratio Li/Lr being between the distance Lr between two positions and the difference (difference distance) Li between the distances from the two positions to the target tag.

The table shown in FIG. 10 records values in two-dimensional coordinates in which a position of a search object (target tag) is set as an origin O (0, 0) and coordinates of a reference position A are (0, 8). (X, Y) in FIG. 10 indicates coordinates of a variation position B when the movement distance Lr from the reference position A is 0.5 m. An angle in FIG. 10 is an angle of the angle (angle OAB) formed by a straight line connecting the position O of the target tag and the reference position A and a straight line connecting the reference position A and the variation position B. A distance in FIG. 10 indicates a distance between the variation position B and the position O of the target tag.

The difference distance Li in FIG. 10 is a distance (Li=La−Lb) obtained by subtracting a distance Lb between the position O of the target tag and the variation position B from the distance La between the position O of the target tag and the reference position A. The difference distance Li is a distance calculated based on a phase change amount between a phase of a signal received from the target tag at the reference position A and a phase of a signal received from the target tag at the variation position B. The ratio Li/Lr in FIG. 10 is a ratio between the movement distance Lr and the difference distance Li.

FIG. 11 is a graph illustrating the relationship between the angle specified based on the values shown in FIG. 10 and the ratio Li/Lr. According to the table shown in FIG. 10 or the graph shown in FIG. 11, the angle of the angle OAB can be determined based on the ratio Li/Lr. That is, when the coordinates of the position A, the coordinates of the position B, and the angle of the angle OAB are specified, the direction in which the target tag exists from the position A can be determined even if the coordinates of the target tag are unknown.

By using the table shown in FIG. 10 or the graph shown in FIG. 11, the angle D shown in FIG. 9 can be calculated based on the movement distance Lr and the difference distance Li. Similarly, the angle D′ shown in FIG. 9 can be calculated based on the movement distance Lr′ and the difference distance Li′. As a result, the position of the target tag illustrated in FIG. 9 can be determined based on the direction (angle D) from the position Pa to the target tag and the direction (angle D′) of the target tag from the second position Pb.

Next, operations of the wireless tag communication device 1 according to the third embodiment will be described.

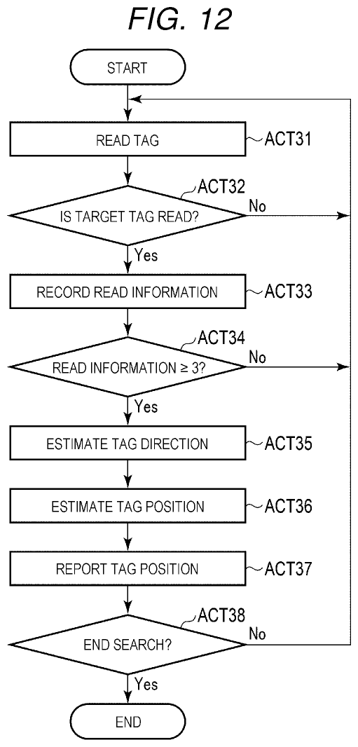

FIG. 12 is a flowchart for explaining an operation example of the wireless tag communication device 1 according to the third embodiment. The processor 21 of the wireless tag communication device 1 operates in a search mode after registering an operator who is a searcher based on information input via the input device 15. After setting an RFID tag to be searched (a target tag) that is designated by the operator, the processor 21 starts reading the target tag in response to an instruction to start the search from the operator (ACT 31). The processor 21 receives, as a reception signal, a response wave output from the RFID tag in a reading area in response to a response request (a read command) from the wireless tag communication device 1.

Based on tag information included in the reception signal, the processor 21 determines whether the RFID tag to be searched (the target tag) is read (ACT 32). When the target tag is not read (ACT 32, NO), the processor 21 returns to ACT 31 and performs reading of the RFID tag.

When the target tag is read (ACT 32, YES), for example, the processor 21 stores (records) read information, which is a reading result of the target tag, in the memory 22 (ACT 33). For example, the processor 21 holds, in the memory 22, read information including a position of an own device (for example, position information indicated by coordinate values) and a phase of the reception signal (the response wave) as the reading result of the target tag.

When the read information that is the reading result of the target tag is recorded, the processor 21 determines whether there are three or more pieces of read information that are the reading result of the target tag (ACT 34). When there are not three or more pieces of read information of the target tag (ACT 34, NO), the processor 21 returns to ACT 31 and performs reading of the RFID tag.

When there are three or more pieces of read information of the target tag (ACT 34, YES), the processor 21 estimates directions from the plurality of positions to the target tag (ACT 35). The processor 21 determines a direction of the target tag from a certain position based on read information obtained at the position and read information obtained at a next position at which the target tag is read. For example, when the target tag is read at first, second, and third positions, the processor 21 specifies a direction from the first position to the target tag and a direction of the target tag from the second position. As described above, the direction from the first position to the target tag is specified based on a ratio between the distance Lr from the first position to the second position and the difference distance Li of distances to the target tag. The direction from the second position to the target tag is specified based on the ratio between the distance Lr′ from the second position to the third position and the difference distance Li′ of distances to the target tag.

When the directions from the plurality of positions to the target tag are estimated, the processor 21 determines a position of the target tag based on coordinates of the plurality of positions and the directions from the respective positions to the target tag (ACT 36). For example, when the directions from the plurality of positions to the target tag are specified, the processor 21 determines the position of the target tag based on the coordinates of the respective positions and the directions from the respective positions to the target tag.

When the position of the target tag is determined, the processor 21 reports the determined position of the target tag (ACT 37). For example, the processor 21 displays information indicating the determined position of the target tag on the display 14. Accordingly, the operator can directly know not a direction in which the target tag exists but the position where the target tag exists.

The processor 21 receives an instruction to end the search. For example, the processor 21 may receive the instruction to end the search when an existence area of the target tag is reported, or may receive the instruction to end the search at any timing. When the instruction to end the search is not given (ACT 38, NO), the processor 21 returns to ACT 31 and performs reading of the RFID tag. When the instruction to end the search is given (ACT 38, YES), the processor 21 ends the search of the target tag.

As described above, the wireless tag communication device according to the third embodiment stores, in a memory, reading results of reading a target tag at no less than three self positions. The wireless tag communication device determines a direction from a first position to the target tag and a direction from a second position to the target tag, based on three reading results stored in the memory. The wireless tag communication device determines a position of the target tag based on the direction from the first position to the target tag and the direction from the second position to the target tag.

Accordingly, according to the wireless tag communication device of the third embodiment, it is possible to specify a position in which the target tag exists, not a direction in which the target tag exists. As a result, according to the wireless tag communication device of the third embodiment, it is possible to report the position where the target tag exists to the operator.

The wireless tag communication device according to the third embodiment determines a first movement distance from the first position to the second position. The wireless tag communication device determines a first difference distance between a distance from the first position to the target tag and a distance from the second position to the target tag. The wireless tag communication device determines the direction from the first position to the target tag based on a ratio between the first movement distance and the first difference distance. The wireless tag communication device determines a second movement distance from the second position to the third position. The wireless tag communication device determines a second difference distance between the distance from the second position to the target tag and a distance from the third position to the target tag. The wireless tag communication device determines the direction from the second position to the target tag based on a ratio between the second movement distance and the second difference distance.

Accordingly, the wireless tag communication device determines the position of the target tag based on the direction from the first position to the target tag and the direction from the second position to the target tag. As a result, according to the wireless tag communication device of the third embodiment, it is possible to specify the position where the target tag exists, and it is possible to report the position where the target tag exists to the operator.

In the embodiments described above, a case where a program executed by the processor is stored in advance in the memory of the device is described. However, the program executed by the processor may be downloaded from a network to the device or may be installed from a storage medium to the device. The storage medium may be any storage medium such as a CD-ROM that can store a program and can be read by the device. Functions obtained by installation or download in advance may be implemented in cooperation with an operating system (OS) or the like in the device.

While certain embodiments have been described, these embodiments have been presented by way of example only, and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in a scope of the disclosure disclosed in the claims and equivalents thereof.

What is claimed is:

1. A wireless tag communication device, comprising:
a communication device configured to communicate with a wireless tag that is a target;
a position detection sensor configured to detect information indicating a self position of the wireless tag communication device;
a memory configured to store the self position, which is specified based on the information detected by the position detection sensor, in association with a reading result of reading the wireless tag by the communication device; and
a processor configured to specify a position of the wireless tag based on reading results of the wireless tag at a plurality of different positions that are stored in the memory.

2. The wireless tag communication device according to claim 1, wherein
the memory stores a first reading result of reading the wireless tag when the self position is a first position and a second reading result of reading the wireless tag when the self position is a second position different from the first position, and
the processor specifies an area where the wireless tag exists based on an overlapping area between a first reading area when the wireless tag is read at the first position and a second reading area when the wireless tag is read at the second position.

3. The wireless tag communication device according to claim 2, wherein
the processor reads the wireless tag in the second reading area narrower than the first reading area from the second position by decreasing an output value of an output signal of the communication device after reading the wireless tag in the first reading area from the first position, and specifies an area where the wireless tag exists based on an overlapping area between the first reading area and the second reading area.

4. The wireless tag communication device according to claim 1, wherein
the memory stores a first reading result of reading the wireless tag when the self position is a first position, a second reading result of reading the wireless tag when the self position is a second position different from the first position, and a third reading result of reading the wireless tag when the self position is a third position different from the second position, and
the processor determines the position of the wireless tag based on a first direction from the first position to the wireless tag and a second direction from the second position to the wireless tag, which are determined based on the first reading result, the second reading result, and the third reading result stored in the memory.

5. The wireless tag communication device according to claim 4, wherein the processor
determines the first direction from the first position to the wireless tag based on a ratio of a movement distance from the first position to the second position to a difference distance, the difference distance being between a distance from the first position to the wireless tag and a distance from the second position to the wireless tag, and
determines the second direction from the second position to the wireless tag based on a ratio of a movement distance from the second position to the third position to a difference distance, the difference distance being between the distance from the second position to the wireless tag and a distance from the third position to the wireless tag.

6. The wireless tag communication device according to claim 1, wherein the plurality of different positions comprise at least two positions.

7. The wireless tag communication device according to claim 1, wherein the plurality of different positions comprise at least three positions.

8. The wireless tag communication device according to claim 1, wherein the processor is further configured to specify a position of the wireless tag based on movement distances between a plurality of positions where the wireless tag to be searched is read.

9. The wireless tag communication device according to claim 1, wherein the position detection sensor is an acceleration sensor, a gyro sensor, or an azimuth sensor.

10. A wireless tag search method, comprising:
acquiring information indicating a self position of an information processing apparatus at which a signal is received from a wireless tag that is a target;
storing the self position in association with a reading result that is based on the signal received from the wireless tag; and
specifying an area where the wireless tag exists based on stored reading results of the wireless tag obtained at a plurality of different positions.

11. The wireless tag search method according to claim 10, wherein
the memory stores a first reading result of reading the wireless tag when the self position is a first position and a second reading result of reading the wireless tag when the self position is a second position different from the first position, and
the processor specifies an area where the wireless tag exists based on an overlapping area between a first reading area when the wireless tag is read at the first position and a second reading area when the wireless tag is read at the second position.

12. The wireless tag search method according to claim 11, further comprising:
reading the wireless tag in the second reading area narrower than the first reading area from the second position by decreasing an output value of an output signal of the communication device after reading the wireless tag in the first reading area from the first position; and
specifying an area where the wireless tag exists based on an overlapping area between the first reading area and the second reading area.

13. The wireless tag search method according to claim 10, further comprising:
storing a first reading result of reading the wireless tag when the self position is a first position, a second reading result of reading the wireless tag when the self position is a second position different from the first position, and a third reading result of reading the wireless tag when the self position is a third position different from the second position; and
determining the position of the wireless tag based on a first direction from the first position to the wireless tag and a second direction from the second position to the wireless tag, which are determined based on the first reading result, the second reading result, and the third reading result stored in the memory.

14. The wireless tag search method according to claim 13, further comprising:
determining the first direction from the first position to the wireless tag based on a ratio of a movement distance from the first position to the second position to a difference distance, the difference distance being between a distance from the first position to the wireless tag and a distance from the second position to the wireless tag; and
determining the second direction from the second position to the wireless tag based on a ratio of a movement distance from the second position to the third position to a difference distance, the difference distance being between the distance from the second position to the wireless tag and a distance from the third position to the wireless tag.

15. The wireless tag search method according to claim 10, wherein the plurality of different positions comprise at least two positions.

16. The wireless tag search method according to claim 10, wherein the plurality of different positions comprise at least three positions.

17. The wireless tag search method according to claim 10, further comprising:
specifying a position of the wireless tag based on movement distances between a plurality of positions where the wireless tag to be searched is read.

18. A radio frequency identification tag communication device, comprising:
a communication device configured to communicate with a radio frequency identification tag that is a target;
a position detection sensor configured to detect information indicating a self position of the radio frequency identification tag communication device;
a memory configured to store the self position, which is specified based on the information detected by the position detection sensor, in association with a reading result of reading the radio frequency identification tag by the communication device; and
a processor configured to specify a position of the radio frequency identification tag based on reading results of the radio frequency identification tag at a plurality of different positions that are stored in the memory.

19. The radio frequency identification tag communication device according to claim 18, wherein
the memory stores a first reading result of reading the radio frequency identification tag when the self position is a first position and a second reading result of reading the radio frequency identification tag when the self position is a second position different from the first position, and
the processor specifies an area where the radio frequency identification tag exists based on an overlapping area between a first reading area when the radio frequency identification tag is read at the first position and a second reading area when the radio frequency identification tag is read at the second position.

20. The radio frequency identification tag communication device according to claim 19, wherein
the processor reads the radio frequency identification tag in the second reading area narrower than the first reading area from the second position by decreasing an output value of an output signal of the communication device after reading the radio frequency identification tag in the first reading area from the first position, and specifies an area where the radio frequency identification tag exists based on an overlapping area between the first reading area and the second reading area.
